(19) United States
(12) Patent Application Publication
(10) Pub. No.: US 2003/0161565 A1
(43) Pub. Date: Aug. 28, 2003

(54) Optical modulator comprising photonic crystals

(75) Inventor: Georg Bastian, Karlsruhe (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/367,891

(22) Filed: Feb. 19, 2003

(30) Foreign Application Priority Data
Feb. 28, 2002 (EP) 02 360 075.2

(51) Int. Cl. G02F 1/035

(52) U.S. Cl. 385/3

(57) ABSTRACT

Optical components are formed from integrated optical waveguides that have, least segmentwise, a periodic variation in the permittivities after the fashion of a photonic crystal. Said period variation is appropriately chosen so as to reduce the group velocity of signals to be transmitted in the optical waveguide. According to the invention, a field that has an influence on the interaction in said optical waveguide and transmitted optical signals is provided along at least part of the integrated photonic crystal. Reducing the group velocity increases the interaction under the influence of the field of an electrical or magnetic nature.

### TECHNICAL FIELD

The invention relates to an optical component that has at least one optical waveguide formed on a substrate. The latter is provided in segments with a periodic variation in the permittivity that causes a reduction in the group velocity of the optical signals to be transmitted in the optical waveguide. The invention is based on a priority application EP 02 360 075.2 which is hereby incorporated by reference.

### BACKGROUND OF THE INVENTION

The constantly increasing demand for bandwidths motivates the telecommunications providers to optimize the performance of their optical networks. At present, there appears to be a consensus that this can only be achieved by the use of a multiplicity of wavelengths k for the transmission of optical signals. All such wavelengths are situated in the so-called third spectral window. At present, Alcatel have recently demonstrated experimentally that it is possible to transmit a data capacity of more than several Tbit/s over several thousand kilometres on a single optical fibre. This maximum performance is achieved in that, in the transmission of data, for example, 365 different wavelengths are transmitted simultaneously via the optical fibre, each of these different wavelengths being modulated at 10 Gbit/s. It emerges clearly that the present development will continue in this direction, i.e. that an increased transmission capacity is inevitably associated with an increase in the number of different wavelengths and also their modulation frequencies.

In the processing of optical systems that are transmitted with the aid of such a large number of different wavelengths and at such high frequencies (for example, 10 Gbit/s per λ), optical components are used that are fitted with an ever-greater number of different units (for example couplers, splitters, isolators, circulators, etc.). This explains the efforts to integrate such units on a substrate.

Many such units are based on the use of a modulated field and are accordingly described as an integrated optical modulator. One of the most used is the Mach-Zehnder interferometer (see FIG. 1), in which the propagation of optical systems can be modulated in one of two arms. As shown in FIG. 1, this modulation is applied and generated via a gate voltage at said arm. In this connection, electrooptical materials (for example lithium niobate or KTP) are used in the optical waveguide in order to achieve a stronger influence of the electrical field on the optical signals. The interference consequently generated at the output of the interferometer may be either constructive or destructive (for example, by shifting the wavelengths or the phase half a cycle) as a function of the applied voltage. Consequently, the intensity of the light at the output of the interferometer is modulated. In order to generate very high frequencies of more than several Gbit/s, the influence of the applied voltage on the propagating optical signals has to be maximized. For this purpose, either the gate structure can be formed very long over one of the two arms of the interferometer or a very strong applied voltage can be used. Both possibilities involve disadvantages since the units should be ever smaller with increasing integration.

A better effect of the electrical field used for the modulation of optical signals can be obtained with the aid of electrical travelling waves. Such travelling waves need, however, an electrical dispersion that is set precisely equal to the dispersion of the light. Since, however, the electrical signal is attenuated along the interaction path, virtually no modulators with any desired high frequencies can be achieved by this concept.

A high modulation frequency of light with the aid of Mach-Zehnder interferometers is restricted by the capacity of the metallic gate structure and the necessary voltages to be applied. Because of the much too great capacities or RC times (R-resistance, C-capacitance), a direct modulation with the aid of quasi-static gate structures is incompatible with the bandwidth of optical communication systems, which, as we have seen above, is more than 10 Gbit/s. Even the use of electrical travelling waves does not make it possible to structure optical modulators with sufficient modulation frequency.

### SUMMARY OF THE INVENTION

The object of the invention is to improve the miniaturization of units of optical components markedly.

The object is achieved according to the invention by an optical component having at least one optical waveguide that is formed on a substrate and that has at least segmentwise a periodic variation in permittivity that produces a reduction in the group velocity of optical signals to be transmitted therein. The period of such variation in permittivity is adapted to treat at least some of the optical signals to be transmitted therein with a field provided at least along a part of the segment having a periodic variation in the permittivity to interact with said optical signals with reduced group velocity.

From patent application U.S. Ser. No. 2001/0006567, it is known to produce a photonic crystal on a substrate of an optical component. The photonic crystal comprises media having different permittivities, said media being arranged in a periodic structure. Said photonic crystal is structured at the crossing point of two integrated optical waveguides. Such a photonic crystal serves as a wavelength-dependent filter and is consequently intended to make it possible to produce passive optical couplers.

From European Patent Application EP 0 964 305, it is known to produce passive optical components that have integrated optical waveguides, with a segment composed of a photonic crystal. Said photonic crystal has a periodic lattice having a variation in the permittivities, this period being suitable for the use of optical wavelengths in the range between 800 nm up to 1800 nm. In this case, the photonic crystals have to be appropriately chosen to have defects that drop certain selected wavelengths of the optical signals.

Proceeding from this prior art, an optical component is developed further, according to the invention, that has integrated optical waveguides, the latter having, at least segmentwise, a periodic variation in the permittivities after the fashion of a photonic crystal. Said periodic variation is appropriately chosen so that the group velocity of optical signals to be transmitted in the optical waveguide is reduced. According to the invention, there is provided along at least a part of the integrated photonic crystal a field that has to interact with the optical signals transmitted in said optical waveguide.

Said field is advantageously modulated. In addition, as a function of the different wavelengths of the optical signals transmitted in said optical waveguide, the periodic variation in the permittivities that has to interact with the field can be chosen appropriately. Passing through at least one segment of a photonic crystal whose “lattice constant” (period) has the same order of magnitude as the wavelength of the optical signals to be processed results in a reduction in the group velocity of said optical signals. As a result, the interaction with the field is advantageously markedly increased. This then makes it possible to design the regions in which an interaction has to take place between optical signals and a field and/or to apply a field of smaller amplitude with equal effect.

According to the invention, the increase in the interaction between optical signals and a field can be used either for a field of an electrical nature or of a magnetic nature. In the latter case, this is used to construct an isolator or circulator. In this connection, either an external magnetic field can be applied or magnetooptical materials can be used.

Advantageous embodiments of the invention emerge from the dependent claims, the description below and the drawing.

### BRIEF DESCRIPTION OF THE DRAWINGS

An exemplary embodiment of the invention is now explained further with the aid of the accompanying drawings.

In the drawings:

FIG. 1 shows a diagrammatic plan view of a Mach-Zehnder interferometer from the prior art;

FIG. 2 shows the dispersion in reciprocal space for a) a homogeneous medium and b) a photonic crystal;

FIG. 3 shows a plan view of a Mach-Zehnder interferometer according to the invention.

### DETAILED DESCRIPTION OF PREFERRED EMBODIMENTS

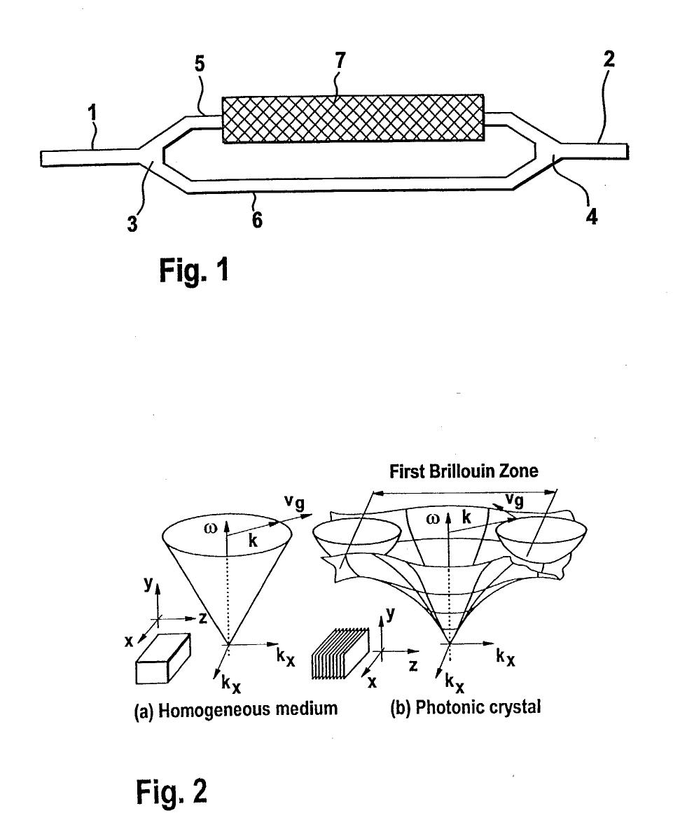

FIG. 1 shows a typical Mach-Zehnder interferometer, such as is used in the prior art. In this case, the entire structure, comprising the two inputs 1 and 2 connected to the respective branchings 3 and 4 that each lead to one end of two arms 5 and 6, one 5 arm being almost completely covered by a gate structure 7, is structured in a substrate of an optical component. Selected optical signals can be systematically processed with such an interferometer. For example, the propagation of optical signals along the arm 5 can be modulated with the aid of a voltage applied via the gate structure 7. Consequently, interferences occur at one of the two branchings 3 or 4 that may be either constructive or destructive as a function of the applied voltage. This then has the result that the intensity of the processed optical signals is modulated accordingly. In order to achieve a very high modulation of more than 10 GHz, as is at present required, either the interaction length between the applied voltage and the optical signals to be processed must be very long or the applied voltage itself must be very high. This has, however, the disadvantages mentioned above.

FIG. 2a) shows the dispersion in the reciprocal space of a homogeneous medium, as is the case for optical signals that are transmitted via a waveguide of a Mach-Zehnder interferometer according to FIG. 1. In contrast to this, FIG. 2b) shows the dispersion for a photonic crystal having a periodic variation in the permittivities along the z-axis. In this case, it can easily be seen in the reciprocal space that a band-like structure is produced. The group velocity, which is given by the relationship v_{g}=∇ₖω(k), i.e. is equal to the increase in the dispersion, is reduced by the occurrence of the band-like structure particularly at the edge of the Brillouin-like zone.

According to the invention, this reduction in the group velocity of optical signals that are transmitted via photonic crystals is utilized by structuring a Mach-Zehnder interferometer as completely integrated from a photonic crystal in a substrate. The period is accordingly chosen that the optical signal to be treated shows a markedly reduced group velocity.

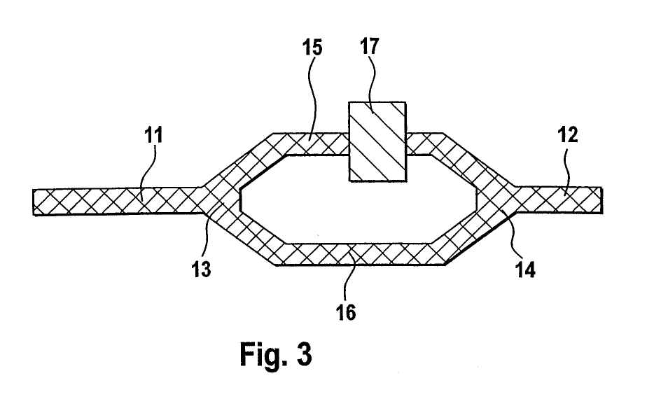

FIG. 3 shows such an example, the Mach-Zehnder interferometer comprising two inputs 11 and 12 that are connected to the respective branchings 13 and 14 that each lead to one end of two arms 15 and 16. In addition, a gate structure 17 is concomitantly structured over one part of the arm 15 in order to apply an electrical field. In this example, the waveguides are continuously provided with electrooptical materials. It is, however, also possible to use electrooptical materials only in the case of the gate structure 17. As shown, not only the inputs 11, 12, but also the branchings 13, 14 and the arms 15 and 16 are made of a photonic crystal. Consequently, the group velocity of specific optical signals whose wavelength is comparable to the period of the photonic crystal and which are transmitted via such a Mach-Zehnder interferometer is reduced. This reduction in the group velocity results in an increase in the interaction with an external field. In the example shown above in FIG. 3, said field is of an electrical nature and is applied via the gate structure 17. Since the optical signals subject to said field then have a reduced group velocity, a markedly reduced interaction length is needed to generate a modulation. Accordingly, the gate structure 17 needs to be constructed substantially smaller than is the case in a current Mach-Zehnder interferometer as shown in FIG. 1. Consequently, a correspondingly greater modulation frequency can be achieved.

It is quite possible to achieve comparable effects by structuring the arm 15 only segmentwise in the region of the gate structure 17 from a photonic crystal. In fact, a reduction in the group velocity is only of relevance where a field is applied. The choice of structuring a Mach-Zehnder interferometer according to the invention segmentwise or completely from a photonic crystal can be linked to the choice of the production method.

Alternative exemplary embodiments of Mach-Zehnder interferometers according to the invention are conceivable. For example, one electric field or, optionally, various electric fields can be provided at a plurality of segments of one or even both arms of the interferometer. It has to be borne in mind that each of these segments in which a field is to be applied have to be structured from photonic crystals. Similarly, various units of optical components that are needed to process optical signals and of which a field is provided that has to interact with said optical signals are structured at least in the segment in which said field is provided from a photonic crystal. The reduction in the group velocity of optical signals transmitted in said segments increases the interaction with the field applied therein, which may be either of an electrical or a magnetic nature. This makes it possible to structure such units smaller.

According to the invention, a Mach-Zehnder interferometer may be provided in which the field is of a magnetic nature. In this case, magnetic materials are advantageously used in structuring the optical waveguides in order to be able to achieve large Faraday effects at least in the segment in which the field is formed. The magnetic field itself can be provided by applying an external magnetic field. However, it is also conceivable to structure a magnetic or magnetizable external coating on the segment that generates a permanent magnetic field producing the Faraday effect in the optical waveguide.

In this connection, the integrated Mach-Zehnder interferometer is structured from a photonic crystal at least in the segment in which the magnetic field is provided. The magnetic field may serve to form a nonreciprocal phase shifter segment. Consequently, such a Mach-Zehnder interferometer can be used as an optical isolator or circulator in which optical signals having given wavelengths can be completely or only partly blocked in one path. Such units may be combined in various ways in order to be integrated in an optical component. The use of the combination, according to the invention, of optical waveguides that are produced from a photonic crystal at least at the segments in which a field is provided that has to interact with the optical signals to be transmitted therein makes it possible to construct such components in a more compact manner and even to optimize their performance (for example, the modulation achieved) at the same time.

1. Optical component having at least one optical waveguide that is formed on a substrate and that has at least segmentwise a periodic variation in permittivity that produces a reduction in the group velocity of optical signals to be transmitted therein, wherein the period of such variation in permittivity is adapted to treat at least some of the optical signals to be transmitted therein with a field provided at least along a part of the segment having a periodic variation in the permittivity to interact with said optical signals with reduced group velocity.

2. Optical component according to claim 1, wherein the field can be modulated.

3. Optical component according to claim 1, wherein the field is of an electrical nature.

4. Optical component according to claim 3, wherein at least the part of the segment of the optical waveguide in which the field is provided comprises electrooptical materials.

5. Optical component according to claim 1, wherein the field is of a magnetic nature.

6. Optical component according to claim 5, wherein at least the part of the segment of the optical waveguide in which the field is provided comprises magnetooptical material.

7. Optical component according to claim 1, wherein said waveguide is part of an integrated Mach-Zehnder interferometer, wherein the field has to serve to form interferences in the optical signals to be transmitted.

8. Optical component according to claim 7, wherein both arms of the integrated Mach-Zehnder interferometer continuously have a periodic variation in the permittivity that causes a reduction in the group velocity of the optical signals to be transmitted therein.

9. Optical component according to claim 1, wherein said waveguide is part of an integrated optical circuit, wherein the field has to serve to control the circuit.

10. Optical component according to claim 1, wherein the field has to serve to form a phase shifter segment that is not reciprocal for the optical signals to be transmitted in the waveguide.

11. Optical component according to claim 7 or 10, wherein said waveguide is part of an integrated optical isolator or circulator.

12. Optical component according to claim 11, wherein the optical waveguides that form said integrated optical isolator or circulator continuously have a periodic variation in the permittivity that causes a reduction in the group velocity of optical signals to be transmitted therein.
